(19) United States
(12) Patent Application Publication
(10) Pub. No.: US 2021/0285407 A1
(43) Pub. Date: Sep. 16, 2021

(54) Canister

(71) Applicant: AISAN KOGYO KABUSHIKI KAISHA, Obu-shi (JP)

(72) Inventor: Kazuho MURATA, Nagoya-shi (JP)

(73) Assignee: AISAN KOGYO KABUSHIKI KAISHA, Obu-shi (JP)

(21) Appl. No.: 17/197,199

(22) Filed: Mar. 10, 2021

(30) Foreign Application Priority Data
Mar. 11, 2020 (JP) 2020-041636

(51) Int. Cl. F02M 25/08; B01D 53/04

(52) U.S. Cl. CPC F02M 25/0854; B01D 2259/4516; B01D 2253/102; B01D 53/0415

(57) ABSTRACT

A canister includes a casing and a plate-shaped partition member disposed in the casing. The partition member includes an outer frame portion and a crosspiece portion disposed within the outer frame portion. The crosspiece portion includes an upstream crosspiece portion and a downstream crosspiece portion. The crosspiece members of the downstream crosspiece portion are oriented in a direction intersecting with the crosspiece members of the upstream crosspiece portion. Downstream surfaces of the crosspiece members of the upstream crosspiece portion are integrated with upstream surfaces of the crosspiece members of the downstream crosspiece portion.

### CROSS-REFERENCE TO RELATED APPLICATIONS

This application claims benefit of Japanese Patent Application Serial No. 2020-041636 filed Mar. 11, 2020, which is hereby incorporated herein by reference in its entirety for all purposes.

### BACKGROUND

The present disclosure relates generally to canisters. More particularly, the present disclosure relates to canisters configured to be disposed in an evaporated fuel processing system of automobiles or other such vehicles.

Conventionally, automobiles or other such vehicles are provided with an evaporated fuel processing system for processing evaporated fuel generated in a fuel tank. The evaporated fuel processing system includes a canister configured to adsorb and desorb (process) the evaporated fuel generated in the fuel tank.

The canister includes a casing having a plurality of adsorbing chambers filled with granular adsorbing materials for adsorbing evaporated fuel, and plate-shaped partition members that hold the adsorbing materials in the adsorbing chambers. The partition members need to function to not only hold the adsorbing materials but also allow the evaporated fuel to flow therethrough. Therefore, various types of partition members have been proposed.

A known partition member of the canister is taught by, for example, JP 2007-270726A. The known partition member includes a rectangular outer frame member (casing), a plurality of parallel plate-shaped members disposed in the frame member at intervals, and a plurality of reinforcement ribs intersecting the plate-shaped members. Further, the plate-shaped members are integrated with the reinforcement ribs while partially overlapping therewith in a flow direction of fluid. The partition member thus constructed functions to not only hold granular adsorbing materials but also allow the fluid to flow therethrough. In addition, the partition member may have an increased strength.

### SUMMARY

According to one aspect of the present disclosure, a canister includes a casing containing granular adsorbing materials, and a plate-shaped partition member disposed in the casing and holding the adsorbing materials. The partition member includes an outer frame portion and a crosspiece portion disposed in the outer frame portion. The crosspiece portion includes an upstream crosspiece portion and a downstream crosspiece portion that are positioned upstream and downstream, respectively, with respect to a fluid flow direction through the canister. The upstream crosspiece portion includes a plurality of crosspiece members positioned at intervals and oriented at a direction intersecting with the fluid flow direction. The downstream crosspiece portion includes a plurality of crosspiece members positioned at intervals and oriented at a direction intersecting with the fluid flow direction and the crosspiece members of the upstream crosspiece portion. The upstream crosspiece portion and the downstream crosspiece portion are positioned relative to each other such that downstream surfaces of the crosspiece members of the upstream crosspiece portion are integrated with upstream surfaces of the crosspiece members of the downstream crosspiece portion so as to define a plurality of flow openings.

According to one aspect of the disclosure, the flow openings are continuous with each other via a plurality of flow channels formed between the crosspiece members of the upstream crosspiece portion and a plurality of flow channels formed between the crosspiece members of the downstream crosspiece portion. Therefore, fluid flows vertically through the flow openings while flowing horizontally along the flow channels of the upstream crosspiece portion and the flow channels of the downstream crosspiece portion. That is, the fluid flows vertically through the flow openings while a portion of the fluid is deflected in two intersecting horizontal directions. Therefore, when the fluid flows through the partition member at a high flow rate, flow resistance can be prevented from being excessively increased. To the contrary, when a flow rate of fluid is low, the flow resistance is relatively increased (throttling effect). That is, the partition member has an excellent flow control effect on the fluid flowing through the canister. Therefore, the canister has increased performance based on the diurnal breathing loss (DBL) test and refueling vapor recovery performance.

Other objects, features, and advantages, of the present disclosure will be readily understood after reading the following detailed description together with the accompanying drawings and the claims.

### BRIEF DESCRIPTION OF THE DRAWINGS

FIG. 1 is a cross-sectional side view of a canister according to a representative embodiment of the present disclosure;

FIG. 2 is a bottom plan view of a partition member (the first pressing plate) of the canister of FIG. 1;

FIG. 3 is a perspective view of the partition member (the first pressing plate) of FIG. 2 as viewed from above;

FIG. 4 is an enlarged, partial schematic plan view of the partition member of FIG. 2, which shows an arrangement of the crosspiece members of an upstream crosspiece portion and the crosspiece members of a downstream crosspiece portion;

FIG. 5 is a cross-sectional view of the partition member of FIG. 2 taken along line V-V in FIG. 4, which shows a shape of the crosspiece members of the upstream crosspiece portion and the crosspiece members of the downstream crosspiece portion;

FIG. 6 is a view similar to FIG. 5, which shows a first modified form of the crosspiece members;

FIG. 7 is a view similar to FIG. 5, which shows a second modified form of the crosspiece members;

FIG. 8 is a view similar to FIG. 5, which shows a third modified form of the crosspiece members;

FIG. 9 is a view similar to FIG. 4, which shows an arrangement of the crosspiece members of an upstream crosspiece portion and the crosspiece members of a downstream crosspiece portion in a first modified embodiment;

FIG. 10 is a view similar to FIG. 4, which shows an arrangement of the crosspiece members of an upstream crosspiece portion and the crosspiece members of a downstream crosspiece portion in a second modified embodiment; and

FIG. 11 is a view similar to FIG. 4, which shows an arrangement of the crosspiece members of an upstream crosspiece portion and the crosspiece members of a downstream crosspiece portion in a third modified embodiment.

### DETAILED DESCRIPTION

As previously described, the known partition member of the canister taught by JP 2007-270726A functions to not only hold the granular adsorbing materials but also allow fluid to flow therethrough.

However, fluid flow passages of the partition member are formed as narrow passages defined or confined by the plate-shaped members and the reinforcement ribs. Therefore, the partition member having such fluid flow passages exhibits a relatively high flow resistance when the fluid flows through the partition member at a high flow rate.

Generally, a partition member of a canister needs to have special fluid-flow characteristics such that its flow resistance is increased (throttling effect) when a flow rate of fluid is low, whereas the flow resistance is not excessively increased when the flow rate of fluid is high. Thus, there is a need in the art for an improved partition member for a canister.

Next, a representative embodiment of the present disclosure will be described with reference to the drawings. Further, forward, backward, rightward, leftward, upward and downward directions described with reference to the figures may be defined simply for descriptive purposes.

This embodiment is directed to a canister 10 to be disposed in an evaporated fuel processing system of a vehicle such as an automobile. Such a canister 10 is configured to adsorb and desorb (process) evaporated fuel generated in a fuel tank (not shown) of an internal combustion engine and to feed the evaporated fuel to an intake system of the engine.

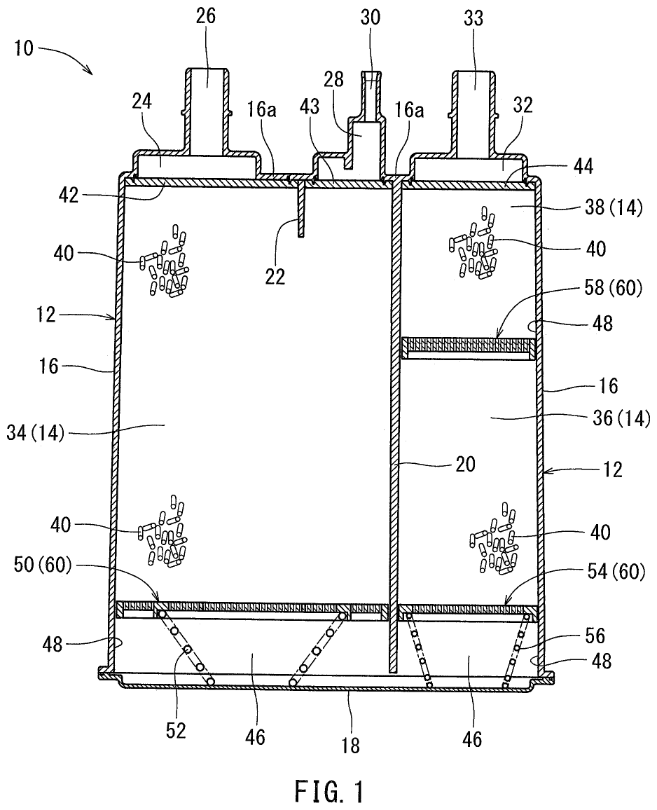

As shown in FIG. 1, the canister 10 includes a substantially rectangular box-shaped resin casing 12. In particular, the casing 12 includes a generally rectangular casing body 16 having an open lower end and a dish-shaped closing member 18 closing the open lower end of the casing body 16. The closing member 18 is preferably connected to the casing body 16 by welding or other such methods. The casing 12 thus constructed includes an adsorbing chamber 14 formed therein. Further, the casing body 16 includes a vertical wall 20 extending from an upper end wall 16a of the casing body 16. In particular, the vertical wall 20 extends from the upper end wall 16a toward the closing member 18 through the adsorbing chamber 14, thereby dividing the adsorbing chamber 14 into a first (left) portion and a second (right) portion that are in fluid communication with each other via a communicating chamber 46 formed in a lower portion of the casing 12.

As shown in FIG. 1, the casing body 16 includes an induction port 26 and a purge port 30 extending upward from the upper end wall 16a thereof. The induction port 26 and the purge port 30 are in fluid communication with the first portion of the adsorbing chamber 14 via an induction cavity 24 and a purge cavity 28, respectively. The induction port 26 is in fluid communication with a gaseous space of the fuel tank whereas the purge port 30 is in fluid communication with an intake duct of the engine (not shown). The casing body 16 also includes an atmosphere port 33 extending upward from the upper end wall 16a thereof. The atmosphere port 33 is in fluid communication with the second portion of the adsorbing chamber 14 via an atmosphere cavity 32. The atmosphere port 33 is open to the surrounding atmosphere.

As shown in FIG. 1, the casing body 16 includes a first gas-permeable pressing plate 50 (a plate-shaped partition member 60) that is horizontally oriented and disposed in the first (left) portion of the adsorbing chamber 14 so as to define a first adsorbing chamber 34 in the first portion of the adsorbing chamber 14. The first adsorbing chamber 34 is in fluid communication with the communicating chamber 46 via the first pressing plate 50. Further, the casing body 16 includes a second gas-permeable pressing plate 54 (the partition member 60) and a gas-permeable buffering plate 58 (the partition member 60) that are horizontally disposed in the second portion of the adsorbing chamber 14 so as to define a second adsorbing chamber 36 and a third adsorbing chamber 38 in the second portion of the adsorbing chamber 14. The second adsorbing chamber 36 is in fluid communication with the communicating chamber 46 via the second pressing plate 54. The third adsorbing chamber 38 is in fluid communication with the second adsorbing chamber 36 via the buffering plate 58.

Each adsorbing chamber 34, 36, 38 is filled with granular adsorbent or adsorbing materials 40 configured to adsorb and desorb the evaporated fuel. An example of the adsorbing materials 40 is columnar granular activated carbon.

As shown in FIG. 1, the casing body 16 includes a partition wall 22 projecting downward from the upper end wall 16a thereof into the first adsorbing chamber 34. The partition wall 22 divides an upper portion of the first adsorbing chamber 34 into two portions, i.e., a first portion facing the induction port 26 and a second portion facing the purge port 30.

As shown in FIG. 1, the casing body 16 includes a (first) permeable sheet-shaped filter 42 attached to the upper end wall 16a and covering the induction port 26 (the induction cavity 24) from below. Further, the casing body 16 includes a (second) permeable sheet-shaped filter 43 attached to the upper end wall 16a and covering the purge port 30 (the purge cavity 28) from below. Further, the casing body 16 includes a (third) permeable sheet-shaped filter 44 attached to the upper end wall 16a and covering the atmosphere port 33 (the atmosphere cavity 32) from below. Each filter 42, 43, 44 is made of sheeted fibrous materials (felt or non-woven fabric).

As shown in FIG. 1, the first pressing plate 50 is movably disposed in the first (left) portion of the adsorbing chamber 14 so as to be vertically movable relative to an inner surface 48 of the casing body 16. Further, the first pressing plate 50 is biased upward by a first spring 52 (a conical coil spring) disposed in the communicating chamber 46. As a result, the first pressing plate 50 is pressed toward the first adsorbing chamber 34 by a spring force of the first spring 52 so that the adsorbing materials 40 can be reliably held in the first adsorbing chamber 34. The first spring 52 is preferably positioned such that a large-diameter coil end contacts the first pressing plate 50 while a small-diameter coil end contacts the cover plate 18.

As shown in FIG. 1, the second pressing plate 54 is movably disposed in the second (right) portion of the adsorbing chamber 14 so as to be vertically movable relative to the inner surface 48 of the casing body 16. Further, the second pressing plate 54 is biased upward by a second spring 56 (a conical coil spring) disposed in the communicating chamber 46. As a result, the second pressing plate 54 is pressed toward the second adsorbing chamber 36 by a spring force of the second spring 56, so that the adsorbing materials 40 can be reliably held in the second adsorbing chamber 36. The second spring 56 is preferably positioned such that a large-diameter coil end contacts the second pressing plate 54 while a small-diameter coil end contacts the cover plate 18.

As shown in FIG. 1, the buffering plate 58 is movably disposed in the second (right) portion of the adsorbing chamber 14 so as to be vertically movable relative to the inner surface 48 of the casing body 16.

Next, an operation of the canister 10 will be described. In a condition in which the engine is stopped or the vehicle is refueled, evaporated fuel-containing gases (first fluid) generated in the fuel tank flows into the first adsorbing chamber 34 via the induction port 26, the induction cavity 24, and the filter 42 such that the evaporated fuel contained in the evaporated fuel-containing gasses is adsorbed by the adsorbing materials 40 in the first adsorbing chamber 34. The evaporated fuel-containing gasses passing through the first adsorbing chamber 34 are then introduced into the second adsorbing chamber 36 via the first pressing plate 50, the communicating chamber 46, and the second pressing plate 54 such that the evaporated fuel contained therein (i.e., the evaporated fuel remaining in the evaporated fuel-containing gasses without being adsorbed by the adsorbing materials 40 in the first adsorbing chamber 34) is adsorbed by the adsorbing materials 40 in the second adsorbing chamber 36.

The evaporated fuel-containing gasses passing through the second adsorbing chamber 36 are then introduced into the third adsorbing chamber 38 via the buffering plate 58 such that the evaporated fuel contained therein (i.e., the evaporated fuel remaining in the evaporated fuel-containing gasses without being adsorbed by the adsorbing materials 40 in the second adsorbing chamber 36) is adsorbed by the adsorbing materials 40 in the third adsorbing chamber 38. As a result, pure gasses (air) containing little to none of the evaporated fuel is produced in the third adsorbing chamber 38. The pure gasses thus produced are released into the atmosphere via the filter 44, the atmosphere cavity 32, and the atmosphere port 33. Further, the evaporated fuel-containing gasses have a relatively high flow rate. Therefore, each of the first pressing plate 50, the second pressing plate 54, and the buffering plate 58 preferably exhibit fluid-flow characteristics that allow its flow resistance (pressure drop) to not excessively increase.

Conversely, in a condition in which the engine is operated, when conditions for purging are satisfied, a manifold negative pressure of the engine is applied to the purge cavity 28 via the purge port 30. As a result, atmospheric air or purge air (gasses) (second fluid) are introduced into the third adsorbing chamber 38 via the atmosphere port 33, the atmosphere cavity 32, and the filter 44. The purge air introduced into the third adsorbing chamber 38 flows therethrough while desorbing the evaporated fuel adsorbed to the adsorbing materials 40 in the third adsorbing chamber 38, and then flows into the second adsorbing chamber 36 via the buffering plate 58.

The purge air introduced into the second adsorbing chamber 36 flows therethrough while desorbing the evaporated fuel adsorbed to the adsorbing materials 40 in the second adsorbing chamber 36, and then flows into the first adsorbing chamber 34 via the second pressing plate 54, the communicating chamber 46, and the first pressing plate 50. The purge air introduced into the first adsorbing chamber 34 flows therethrough while desorbing the evaporated fuel adsorbed to the adsorbing materials 40 in the first adsorbing chamber 34. As a result, the purge air containing the evaporated fuel is produced in the first adsorbing chamber 34. The purge air containing the evaporated fuel thus produced is sent to the engine via the filter 43, the purge cavity 28, and the purge port 30. Further, the purge air (gasses) introduced into the third adsorbing chamber 38 and flowing toward the purge port 30 has a relatively low flow rate. Therefore, each of the first pressing plate 50, the second pressing plate 54, and the buffering plate 58 preferably have fluid-flow characteristics that allow its flow resistance to be relatively increased (throttling effect).

Next, a structure of the first pressing plate 50, the second pressing plate 54, and the buffering plate 58 (the partition member 60) will now be described. The first pressing plate 50, the second pressing plate 54, and the buffering plate 58 have substantially the same structure as each other. Therefore, the first pressing plate 50 will be described as a representative of the partition member 60.

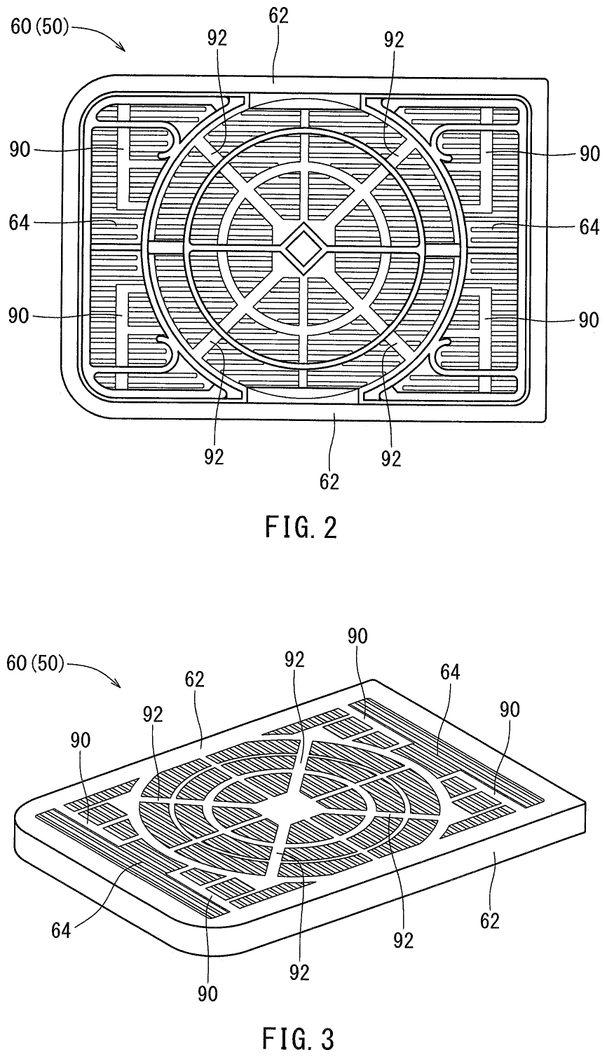

As shown in FIGS. 2 and 3, the partition member 60 (the first pressing plate 50) is a plate-shaped member that is integrally formed by resin molding method. The partition member 60 includes an outer frame portion 62 and a crosspiece portion 64 coupled to and disposed in the frame portion 62. The frame portion 62 is reinforced by variously shaped (linear or curved) ribs 90 and 92 that are continuously formed therein as a portion thereof. However, the cross piece portion 64 is positioned in the frame portion 62 so as to not overlap with the ribs 90 and 92. Further, due to formation of the ribs 90 and 92, when the partition member 60 is manufactured, molten resin can smoothly and uniformly flow, so that the partition member 60 is reliably formed without quality failure.

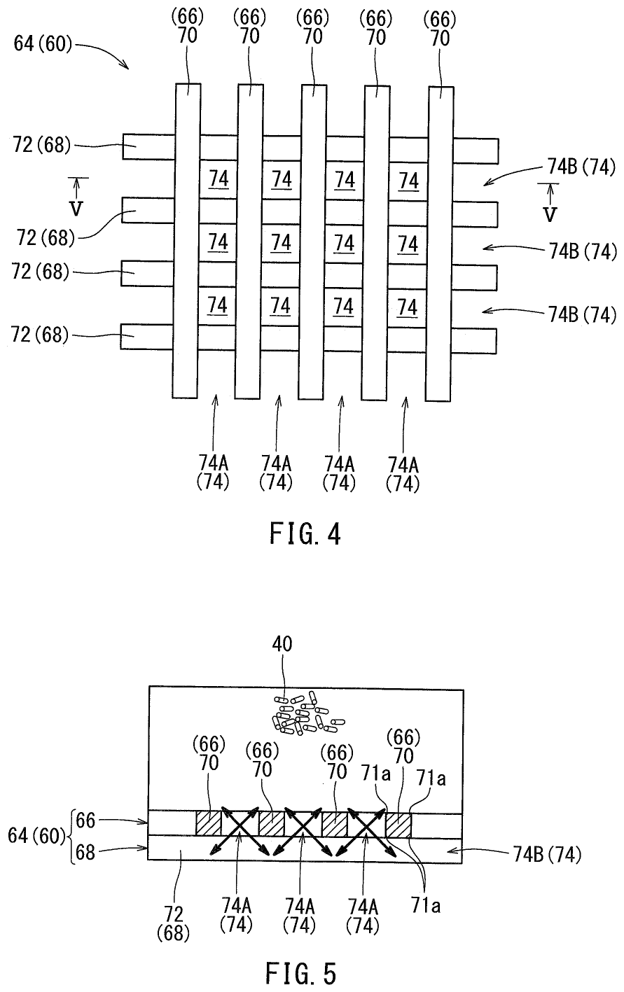

As shown in FIGS. 4 and 5, the crosspiece portion 64 includes an upstream (first) crosspiece portion 66 and a downstream (second) crosspiece portion 68 that are adjoined to each other. Further, terms “upstream” and “downstream” are determined with reference to a flow direction of the evaporated fuel-containing gases generated in the fuel tank passing through the partition member 60 (the first pressing plate 50) from the first adsorbing chamber 34 to the communicating chamber 46 (which may be referred to as a fluid flow direction).

As shown in FIGS. 4 and 5, the upstream crosspiece portion 66 comprises a plurality of (upstream or first) parallel, spaced-apart, rectangular rod-shaped crosspiece members 70. In particular, the crosspiece members 70 are spaced at certain intervals such that the adsorbing materials 40 positioned on the partition member 60 are prevented from passing through spaces formed therebetween. In this embodiment, the crosspiece members 70 are elongate, liner members. The crosspiece members 70 are oriented so as to intersect with the flow direction of the evaporated fuel-containing gases.

As shown in FIGS. 4 and 5, the downstream crosspiece portion 68 comprises a plurality of (downstream or second) parallel, spaced-apart, rectangular rod-shaped crosspiece members 72. In particular, the crosspiece members 72 are spaced at the same intervals as the crosspiece members 70. The crosspiece members 72 intersect with the crosspiece members 70. In this embodiment, similar to the crosspiece members 70, the crosspiece members 72 are formed as elongate, linear members. The crosspiece members 72 are oriented so as to intersect with the flow direction of the evaporated fuel-containing gases.

As shown in FIG. 4, in this embodiment, the crosspiece members 70 and the crosspiece members 72 are oriented perpendicular to each other. Further, as shown in FIG. 5, in this embodiment, the upstream crosspiece portion 66 and the downstream crosspiece portion 68 are combined with each other in a condition in which lower (downstream) surfaces of the crosspiece members 70 engage and are integrated with upper (upstream) surfaces of the crosspiece members 72.

As shown in FIG. 5, each of the crosspiece members 70 and the crosspiece members 72 has a rectangular cross-sectional shape in a transverse cross section, i.e., a quadrilateral shape having four corners 71a in transverse cross section.

As previously described, in the present embodiment, the crosspiece portion 64 of the partition member 60 is constructed of the crosspiece members 70 of the upstream crosspiece portion 66 and the crosspiece members 72 of the downstream crosspiece portion 68 that orthogonally intersect with each other. Consequently, as shown in FIGS. 4 and 5, a plurality of rectangular flow openings 74 are defined or formed by the crosspiece members 70 and the crosspiece members 72 that intersect with each other. In other words, the flow openings 74 are defined by the intersection of a plurality of (first) horizontal parallel flow channels 74A formed between the crosspiece members 70 with a plurality of (second) parallel horizontal flow channels 74B formed between the crosspiece members 72. Therefore, the flow openings 74 thus formed are continuous with (in fluid communication with) each other via the flow channels 74A and 74B and not isolated from each other. As a result, as shown by arrows in FIG. 5, the fluid flows (vertically) through the flow openings 74 while flowing (horizontally) along the flow channels 74A and 74B that intersect with each other. That is, the partition member 60 allows the fluid to flow vertically through the flow openings 74 while deflecting a portion of the fluid in two horizontal intersecting directions. The number of the crosspiece members 70 and the crosspiece members 72 can be changed as necessary.

According to the partition member 60 thus constructed, when the fluid flows through the partition member 60 at a high flow rate (e.g., when the vehicle is refueled), flow resistance (of the partition member 60) can be prevented from being excessively increased. To the contrary, when a flow rate of fluid is low, the flow resistance is relatively increased (throttling effect). That is, the partition member 60 has an excellent flow control effect on the fluid flowing through the canister 10. Therefore, the canister 10 has increased performance based on the diurnal breathing loss (DBL) test and refueling vapor recovery performance.

Further, the crosspiece portion 64 of the partition member 60 is constructed of the crosspiece members 70 and the crosspiece members 72 that intersect with each other. That is, the crosspiece portion 64 has a mesh or lattice structure. Therefore, the partition member 60 can reliably hold the adsorbing materials thereon. Therefore, any additional members (e.g., urethane sheets) can be omitted.

Further, the crosspiece portion 64 formed by combination of the crosspiece members 70 and the crosspiece members 72 has an increased rigidity. Therefore, the crosspiece member 64 functions as a reinforcement member. In addition, the crosspiece portion 64 having the lattice shape functions to reduce pressure loss of the fluid.

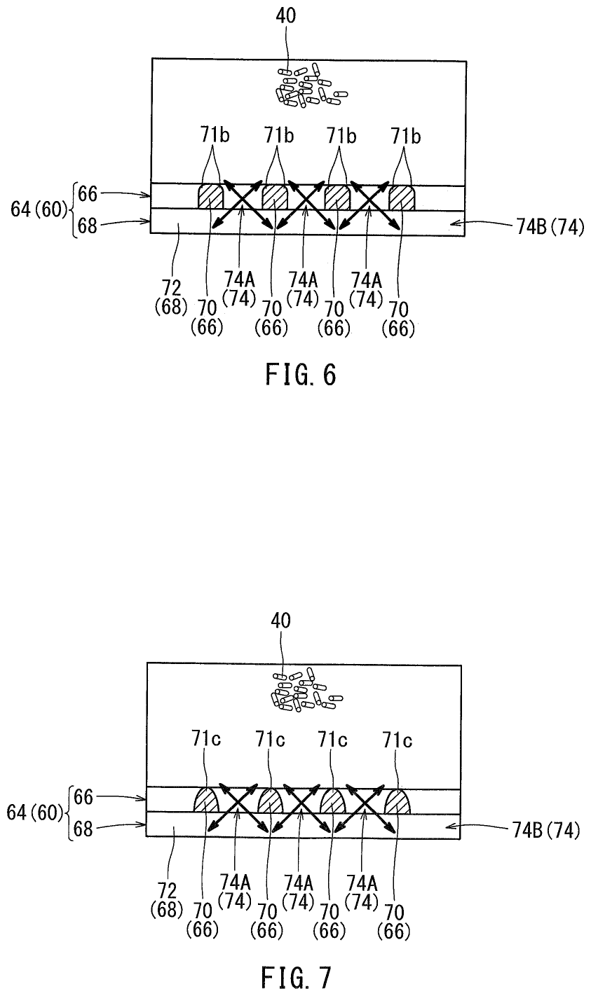

Next, various (first to third) modified forms of the crosspiece portion 64 will be described with reference to FIGS. 6 to 8. Further, because the modified forms of the crosspiece portion 64 relates to the representative form of the crosspiece portion 64 described above, only the constructions that are different from the representative form of the crosspiece portion 64 will be explained in detail. In particular, the modified forms of the crosspiece portion 64 are different from the representative form of the crosspiece portion 64 in that each of the crosspiece members 70 and the crosspiece members 72 is changed in transverse cross-sectional shape. Therefore, only the constructions that are different from the representative form of the crosspiece portion 64 will be hereinafter explained.

As shown in FIG. 6, in the first modified form of the crosspiece portion 64, each crosspiece member 70 and each crosspiece member 72 has a substantially rectangular shape in transverse cross section, i.e., a quadrilateral shape having four corners in transverse cross section. However, unlike the representative form of the crosspiece portion 64 shown in FIG. 5, in this embodiment, two of the four corners are rounded corners 71b. In other embodiments, all of the four corners may be shaped into rounded corners.

As shown in FIG. 7, in the second modified form of the crosspiece portion 64, unlike the representative form of the crosspiece portion 64 shown in FIG. 5, in this embodiment, each crosspiece member 70 and each crosspiece member 72 has a substantially semi-elliptical shape with a rounded top 71c in transverse cross section.

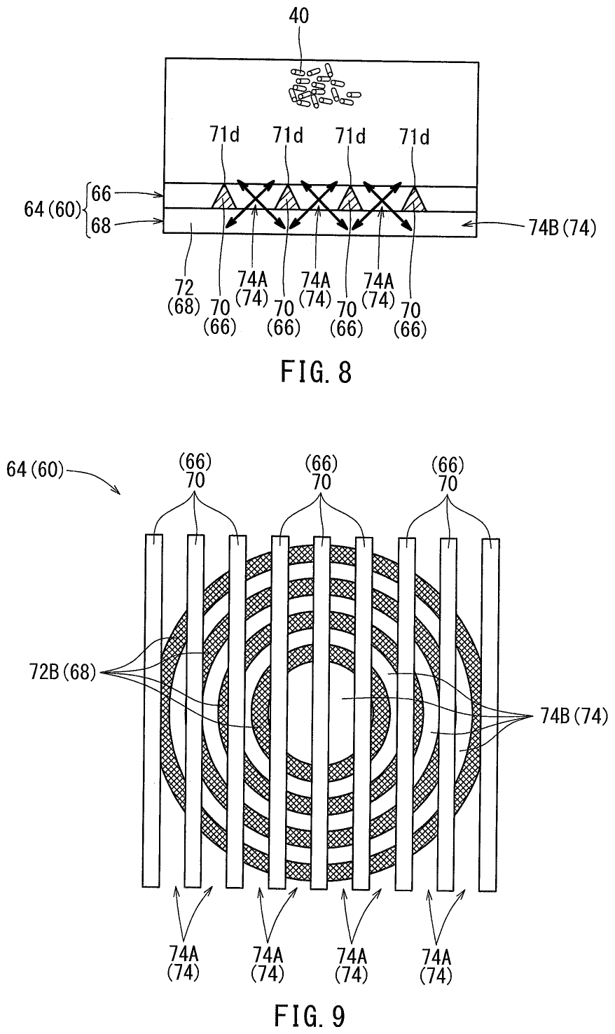

As shown in FIG. 8, in the third modified form of the crosspiece portion 64, unlike the representative form of the crosspiece portion 64 shown in FIG. 5, in this embodiment, each of the crosspiece members 70 and the crosspiece members 72 has a triangular shape with an acute-angled top 71d in transverse cross section.

Next, various (first to third) modified embodiments of the representative embodiment of the crosspiece portion 64 shown in FIG. 4 will be described with reference to FIGS. 9 to 11. Further, because the modified embodiments are similar to the representative embodiment, only the constructions that are different from the representative embodiment will be explained in detail. In particular, the modified embodiments are respectively different from the representative embodiment in that the crosspiece portion 64 is changed in shape and arrangement. Therefore, only the constructions that are different from the embodiment will be hereinafter explained.

As shown in FIG. 9, the first modified embodiment is different from the representative embodiment in that the downstream rod-shaped crosspiece members 72 of the representative embodiment shown in FIG. 4 are simply replaced with a plurality of downstream radially-spaced concentric annular crosspiece members 72B disposed at fixed intervals. Therefore, similar to the representative embodiment, the plurality of rectangular flow openings 74 are defined or formed by the crosspiece members 70 and the crosspiece members 72B that intersect with each other. However, unlike the representative embodiment, the flow openings 74 have various shapes and sizes. According to the first modified embodiment, similar to the representative embodiment, the partition member 60 has the excellent flow control effect on the fluid. In other embodiments, the downstream concentric annular crosspiece members 72B may be positioned at random intervals as necessary.

As shown in FIG. 10, the second modified embodiment is different from the representative embodiment shown in FIG. 4 in that the second rod-shaped crosspiece members 72 of the representative embodiment are simply replaced with a single (continuous) spiral crosspiece member 72C having uniformly-spaced spaced spiral turns. Therefore, similar to the representative embodiment, the plurality of rectangular flow openings 74 are defined or formed by the crosspiece members 70 and the crosspiece member 72C that intersect with each other. However, unlike the representative embodiment, the flow openings 74 have various shapes and sizes. According to the second modified embodiment, similar to the representative embodiment, the partition member 60 has the excellent flow control effect on the fluid. In other embodiments, the spiral turns of the spiral crosspiece member 72C may non-uniformly or randomly spaced.

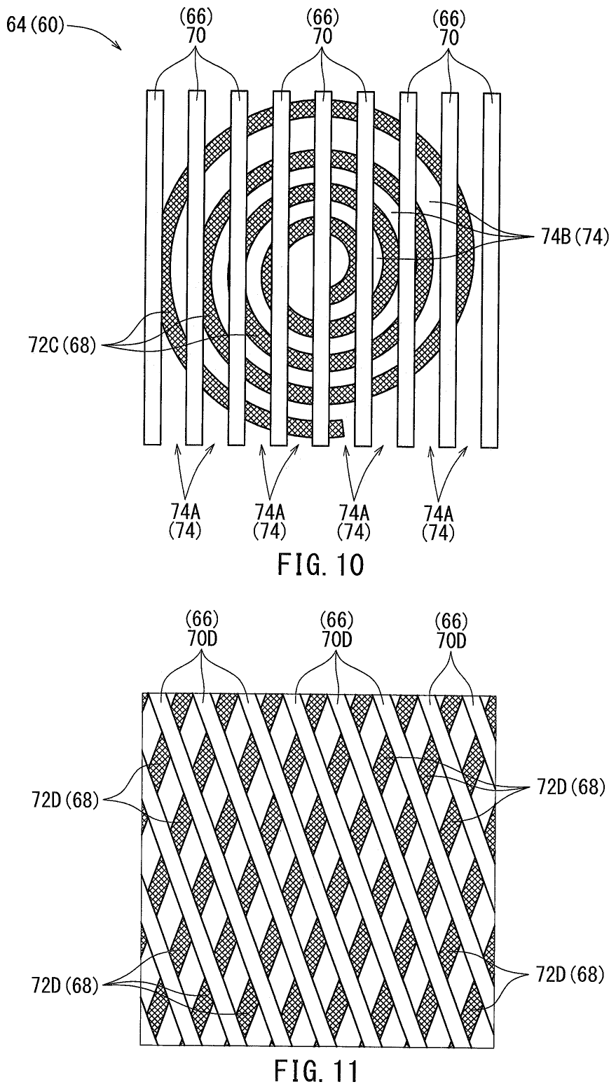

As shown in FIG. 11, the third modified embodiment is different from the representative embodiment shown in FIG. 4 in that first rod-shaped crosspiece members 70 and the second rod-shaped crosspiece members 72 of the representative embodiment are replaced with a plurality of first rod-shaped crosspiece members 70D and a plurality of second rod-shaped crosspiece members 72D, respectively. The first crosspiece members 70D are uniformly spaced apart at fixed intervals and the second crosspiece members 72D are uniformly spaced apart at fixed intervals. However, unlike the representative embodiment, the first crosspiece members 70D and the second crosspiece members 72D obliquely intersect with each other. According to the third modified embodiment, similar to the representative embodiment, the partition member 60 has the excellent flow control effect on the fluid. In other embodiments, the first crosspiece members 70D and the second crosspiece members 72D may be non-uniformly or randomly spaced.

Naturally, various changes and modifications may be made to the partition member 60. For example, the shape and the arrangement of the first and second crosspiece members described above can be changed provided that the flow openings can be defined by the intersection of the first horizontal flow channels formed between the first crosspiece members with the second horizontal flow channels formed between the second crosspiece members. Further, the shape and the arrangement of the first and second crosspiece members described above can be combined with each other.

Representative examples of the present disclosure have been described in detail with reference to the attached drawings. This detailed description is merely intended to teach a person of skill in the art further details for practicing preferred aspects of the present disclosure and is not intended to limit the scope of the disclosure. Only the claims define the scope of the claimed disclosure. Therefore, combinations of features and steps disclosed in the foregoing detail description may not be necessary to practice the disclosure in the broadest sense, and are instead taught merely to particularly describe detailed representative examples of the disclosure. Moreover, the various features taught in this specification may be combined in ways that are not specifically enumerated in order to obtain additional useful embodiments of the present disclosure.

What is claimed is:

1. A canister, comprising:
a casing containing granular adsorbing materials and a plate-shaped partition member disposed in the casing and supporting the adsorbing materials within the casing,
wherein the partition member includes an outer frame portion and a crosspiece portion coupled to and disposed in the outer frame portion,
wherein the crosspiece portion includes an upstream crosspiece portion and a downstream crosspiece portion that are positioned upstream and downstream, respectively, with respect to a fluid flow direction through the casing,
wherein the upstream crosspiece portion includes a plurality of crosspiece members that are spaced apart at intervals while being oriented in a direction intersecting the fluid flow direction, wherein each crosspiece member of the upstream crosspiece portion has an upstream surface and a downstream surface,
wherein the downstream crosspiece portion includes a plurality of crosspiece members that are spaced apart at intervals while being oriented in a direction intersecting the fluid flow direction and the crosspiece members of the upstream crosspiece portion, wherein each crosspiece member of the downstream crosspiece portion has an upstream surface and a downstream surface, and
wherein the upstream crosspiece portion and the downstream crosspiece portion are connected with each other such that the downstream surfaces of the crosspiece members of the upstream crosspiece portion are integrated with the upstream surfaces of the crosspiece members of the downstream crosspiece portion so as to define a plurality of flow openings.

2. The canister of claim 1, wherein the crosspiece members of the upstream crosspiece portion comprise a plurality of elongate, parallel linear crosspiece members, and wherein the crosspiece members of the downstream crosspiece portion are formed as a plurality of parallel, elongate linear crosspiece members.

3. The canister of claim 2, wherein the crosspiece members of the upstream crosspiece portion and the crosspiece members of the downstream crosspiece portion orthogonally intersect with each other.

4. The canister of claim 1, wherein the crosspiece members of the upstream crosspiece portion or the downstream crosspiece portion are formed as parallel linear crosspiece members whereas the crosspiece members of the other of the upstream crosspiece portion and the downstream crosspiece portion are formed as a plurality of annular crosspiece members or a single spiral crosspiece member.

5. The canister of claim 1, wherein the crosspiece members of at least one of the upstream crosspiece portion and the downstream crosspiece portion have a triangular shape in transverse cross section.
